(19) United States
(12) Patent Application Publication
(10) Pub. No.: US 2004/0020609 A1
(43) Pub. Date: Feb. 5, 2004

(54) Ratchet-like system for winding a rolling door assembly

(75) Inventors: Normand Savard, Drummondville (CA); Yannick Funk, Drummondville (CA); Jonathan Lauzier, St-Eugene (CA)

Correspondence Address: MERCHANT & GOULD PC, P.O. BOX 2903, MINNEAPOLIS, MN, 55402-0903, US

(73) Assignee: Canimex Inc., Drummondville (CA)

(21) Appl. No.: 10/411,529

(22) Filed: Apr. 10, 2003

(30) Foreign Application Priority Data
Apr. 10, 2002 (CA) 2,381,027
Apr. 10, 2002 (CA) 2,381,054

(51) Int. Cl. E06B 9/08

(52) U.S. Cl. 160/133

(57) ABSTRACT

A ratchet-like system for winding a rolling door assembly. The ratchet-like system includes a support bracket, a cam, and a biasing device. The support bracket is preferably mounted onto a fixed structure of the rolling door assembly. The cam is pivotally mounted about the support bracket and positioned adjacent to a portion of an overhead shaft of the assembly. The cam is shaped and sized to cooperate with this portion of the overhead shaft between a first position, where the cam allows rotation of the overhead shaft along a first direction, and a second position, where the cam has a surface engaged with the overhead shaft and where further rotation of the overhead shaft along a second direction, opposite to the first direction, is blocked by the cam. The biasing device is used for urging the surface of the cam onto the overhead shaft. The ratchet-like system is particularly useful for adjustably controlling the rotation of the overhead shaft of the rolling door assembly during the winding thereof.

### FIELD OF THE INVENTION

The present invention relates to a ratchet-like system. More particularly, the present invention relates to a ratchet-like system for winding a rolling door assembly, such as mini-warehouse doors, commercial rolling steel doors, and the like, for example. The present invention also relates to a rolling door assembly provided with such a ratchet-like system and to a kit for assembling the ratchet-like system. The ratchet-like system is namely intended to adjustably control the rotation of the overhead shaft of the rolling door assembly during the winding thereof.

### BACKGROUND OF THE INVENTION

Rolling door assemblies, such as mini-warehouse doors, commercial rolling steel doors, and the like, are very well known in the art.

These rolling door assemblies typically comprise an overhead shaft which is mounted onto a fixed structure, a drum mounted about the overhead shaft, and a door curtain foldable (i.e. wound, coiled-up, etc.) about the drum and unfoldable from the same via a rotation of the drum so as to alternatively lower and raise the curtain, i.e. operate the door. Generally, these rolling door assemblies also generally comprise at least one, but typically a pair of, counterbalancing spring(s) having ends operatively connected to corresponding parts of the assembly for providing the same with a suitable counterbalancing force. This counterbalancing force is used in order to decrease force required to open the door and also facilitate its closing.

Also known in the art are two main types of rolling door assemblies, namely “dead shaft” rolling door assemblies and “live shaft” rolling door assemblies.

A “dead shaft” rolling door assembly is one in which, after proper installation thereof, the overhead shaft is securely fixed and tightened onto the support structure by means of brackets and corresponding fasteners, and thus does not rotate during normal operation of the rolling door assembly. In contrast, a “live shaft” rolling door assembly is one in which, after proper installation thereof, the overhead shaft is pivotally connected to the fixed structure and rotates thereabout during normal operation of the rolling door assembly.

In the case of a “dead shaft” rolling door assembly, the drum is pivotally mounted about the overhead shaft and rotates thereabout, and each counterbalancing spring typically has first and second ends mounted onto the shaft and drum respectively so as to be wound and unwound accordingly, depending on the operation of the door assembly, so as to provide a corresponding counterbalancing force thereto.

In the case of a “live shaft” rolling door assembly, the drum is securely mounted about the overhead shaft and rotatable therewith with respect to the fixed structure, and each counterbalancing spring typically has first and second ends mounted onto the drum and the fixed structure respectively so as to be wound and unwound accordingly, depending on the operation of the door assembly, so as to provide a corresponding counterbalancing force thereto.

It is also known in the art that with “dead shaft” rolling door assemblies for example, the winding thereof needs to be properly calibrated in order to ensure a suitable operation of the door assembly. Typically, an installer must untighten the brackets so as to untighten the overhead shaft of the assembly from its fixed structure, and rotate said shaft with respect to the drum by means of a tool, such as a pipe wrench for example, in order to provide the counterbalancing spring with a suitable load, such that the latter may offer a corresponding suitable counterbalancing force. A problem associated with this type of winding is that it is carried out at elevated heights, typically using a ladder, given the fact that the overhead shafts of rolling door assemblies are generally located well above ground level or well out of human reach. Another problem associated with this type of winding is that an installer must typically use both hands to secure movements of the assembly and also operate the pipe wrench in order to secure movement of the overhead shaft with respect to the drum. Another problem associated with the above-mentioned type of winding is that the rolling door assembly and the parts thereof are generally quite heavy, and thus a considerable effort is required from the installer to carry out the above-mentioned maneuvers, often causing him to force onto the parts and causing him also to undertake very precarious movements and/or positions, which can be very dangerous. Another problem associated with this type of winding is that if the rolling door assembly is not properly held into place by the installer during the winding phase, the shaft may start to roll and thus the door assembly may fall to the ground, which is very disadvantageous. The above-discussed problems have been known to give rise to substantial damages to property and/or serious injuries to people.

Hence, in light of the aforementioned, there is a need for an improved system and/or method for winding a rolling door assembly which would be able to overcome some of the aforementioned problems.

### SUMMARY OF THE INVENTION

The object of the present invention is to provide a system which, by virtue of its design and components, satisfies some of the above-mentioned needs and is thus an improvement over other known devices and/or methods in the prior art.

The present invention is particularly advantageous in that it is intended to adjustably control the rotation of the overhead shaft of the rolling door assembly during the winding thereof.

In accordance with the present invention, the above object is achieved with a ratchet-like system for winding a rolling door assembly having an overhead shaft mounted about a fixed structure and rotatable thereabout along opposite first and second directions, a drum mounted about said overhead shaft, a door curtain foldable about the drum and unfoldable from the same via a rotation of the drum, and a counterbalancing spring operatively connected between the overhead shaft and the drum for counterbalancing the rolling door assembly when the overhead shaft is secured to the fixed structure, the ratchet-like system comprising:

at least one support bracket;

at least one cam pivotally mounted about the at least one support bracket and positioned adjacent to a portion of the overhead shaft, said at least one cam being shaped and sized to cooperate with said portion of the overhead shaft between a first position, where the at least one cam allows rotation of the overhead shaft along the first direction, and a second position, where the at least one cam has a surface engaged with the overhead shaft and where further rotation of the overhead shaft along the second direction is blocked by the at least one cam; and

biasing means for urging the surface of the at least one cam onto the overhead shaft.

According to another aspect of the present invention, there is also provided a ratchet-like system for winding a rolling door assembly having an overhead shaft mounted about a fixed structure and rotatable thereabout along opposite first and second directions, the ratchet-like system comprising:

at least one support bracket;

at least one cam pivotally mounted about the at least one support bracket and positioned adjacent to a portion of the overhead shaft, said at least one cam being shaped and sized to cooperate with said portion of the overhead shaft between a first position, where the at least one cam allows rotation of the overhead shaft along the first direction, and a second position, where the at least one cam has a surface engaged with the overhead shaft and where further rotation of the overhead shaft along the second direction is blocked by the at least one cam; and

biasing means for urging the surface of the at least one cam onto the overhead.

According to yet another aspect of the present invention, there is also provided a kit for assembling a ratchet-like system for winding a rolling door assembly having an overhead shaft mounted about a fixed structure and rotatable thereabout along opposite first and second directions, a drum mounted about said overhead shaft, a door curtain foldable about the drum and unfoldable from the same via a rotation of the drum, and a counterbalancing spring operatively connected between the overhead shaft and the drum for counterbalancing the rolling door assembly when the overhead shaft is secured to the fixed structure, the kit comprising:

a support bracket; and

a cam pivotally mountable about the support bracket and positionable adjacent to a portion of the overhead shaft, said cam being shaped and sized so that, once the ratchet-like system assembled, the cam cooperates with said portion of the overhead shaft between a first position, where the cam allows rotation of the overhead shaft along the first direction, and a second position, where the cam has a surface engaged with the overhead shaft and where further rotation of the overhead shaft along the second direction is blocked by the cam.

The objects, advantages and other features of the present invention will become more apparent upon reading of the following non-restrictive description of preferred embodiments thereof, given for the purpose of exemplification only with reference to the accompanying drawings.

### BRIEF DESCRIPTION OF THE DRAWINGS

FIG. 1 is a perspective view of a ratchet-like system according to a first preferred embodiment of the invention, said ratchet-like system being shown mounted onto a fixed structure.

FIG. 2 is another perspective view of what is shown in FIG. 1.

FIG. 3 is an exploded view of the ratchet-like system of FIG. 1, said ratchet-like system being shown in relation to a rolling door assembly and a fixed structure.

FIG. 4 is an assembled view of what is shown in FIG. 3, the overhead shaft of the rolling door assembly being shown adjusted by means of a pipe wrench.

FIG. 5 is a front plan view of the ratchet-like system of FIG. 4 cooperating with the overhead shaft of the rolling door assembly, the overhead shaft being shown rotated along a first direction.

FIG. 6 is another front plan view of what is shown in FIG. 5, the overhead shaft being now shown blocked by a cam when rotated along a second direction.

FIG. 7 is an exploded view of a ratchet-like system according to another preferred embodiment of the invention.

FIG. 8 is a top plan view of the ratchet-like system of FIG. 7 shown in an assembled configuration.

FIG. 9 is a side elevational view of what is shown in FIG. 8.

FIG. 10 is a cross-sectional view taken along line X-X of the ratchet-like system shown in FIG. 9.

FIG. 11 is a cross-sectional view taken along line XI-XI of the ratchet-like system shown in FIG. 9.

FIG. 12 is a perspective view of a ratchet-like system according to yet another preferred embodiment of the invention, said ratchet-like system being used as a winding tool.

FIG. 13 is a perspective view of the ratchet-like system of FIG. 12, said ratchet-like system being shown cooperating with an overhead shaft when rotated along a first direction.

FIG. 14 is another perspective view of the ratchet-like system of FIG. 12, the ratchet-like system being shown cooperating with an overhead shaft, said overhead shaft being shown blocked by a cam when rotated along a second direction.

### DETAILED DESCRIPTION OF A PREFERRED Embodiment Of The Invention

In the following description, the same numerical references refer to similar elements. The embodiments shown in the figures are preferred.

In the context of the present description, the expression “rolling door assembly” includes various types of rolling door assemblies, such as mini-warehouse doors, commercial rolling steel doors, and the like. Although the present invention was primarily designed for a dead shaft rolling door assembly, it may be used with other kinds of rolling door assemblies, such as fire doors or shutters, or with any other door assemblies using an overhead shaft, whether “dead” or “live”, as apparent to a person skilled in the art. For this reason, the expression “dead shaft” and/or “rolling door assembly” should not be taken as to limit the scope of the present invention and includes all other kinds of doors assemblies or items with which the present invention may be used and could be useful.

Moreover, in the context of the present description, the expressions “door” and “assembly”, “curtain” and “door”, “counterbalancing shaft” and “overhead shaft”, “system” and “device”, as well as any other equivalent expressions and/or compound words thereof, may be used interchangeably. The same applies for any other mutually equivalent expressions, such as “plate” and “bracket” for example, as apparent to a person skilled in the art.

In addition, although the preferred embodiment of the present invention as illustrated in the accompanying drawings comprises various components such as an orifice, fasteners, a safety device, a spring, a lever arm, a knurled surface, a second cam, etc., and although the preferred embodiment of ratchet-like system 1 and corresponding parts of the present invention as shown consists of certain geometrical configurations as explained and illustrated herein, not all of these components and geometries are essential to the invention and thus should not be taken in their restrictive sense, i.e. should not be taken as to limit the scope of the present invention. It is to be understood, as also apparent to a person skilled in the art, that other suitable components and cooperations thereinbetween, as well as other suitable geometrical configurations may be used for the ratchet-like system 1 according to the present invention, as will be briefly explained herein and as can be easily inferred herefrom, without departing from the scope of the invention.

Broadly described, the ratchet-like system 1 according to the present invention, as exemplified in the accompanying drawings, is a ratchet-like system 1 devised to facilitate the winding of a rolling door assembly 3, such as mini-warehouse doors, commercial rolling steel doors, and the like, but may also be used for other types of installations where a torque must be applied onto a shaft 5 and where said torque must be maintained.

The ratchet-like system 1 according to the present invention is particularly useful for winding a rolling door assembly 3 having an overhead shaft 5 mounted about a fixed structure 7 and rotatable thereabout along opposite first and second directions. The rolling door assembly 3 generally further comprises a drum 9 mounted about the overhead shaft 5 and a door curtain 11 foldable about the drum 9 and unfoldable from the same via rotation of the drum 9. The rolling door assembly 3 may also comprise a counterbalancing spring (not shown) operatively connected between corresponding parts of the assembly 3 for counterbalancing the same. In the case of a “dead shaft” rolling door assembly 3 for example, the counterbalancing spring is operatively connected between the overhead shaft 5 and the drum 9 for counterbalancing the rolling door assembly 3 when the overhead shaft 5 is secured to the fixed structure, typically by means of U-shaped brackets and corresponding fasteners for example. It is worth mentioning that, instead of using a counterbalancing spring, the rolling door assembly 3 according to the present invention may be counterbalanced by other suitable means, such as counterweights for example, as apparent to a person skilled in the art.

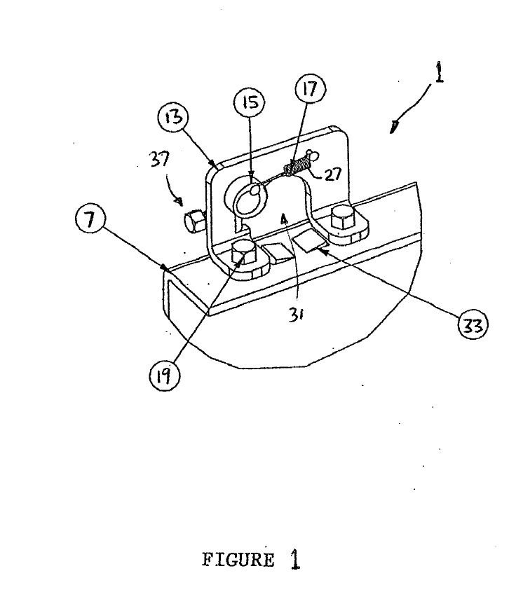

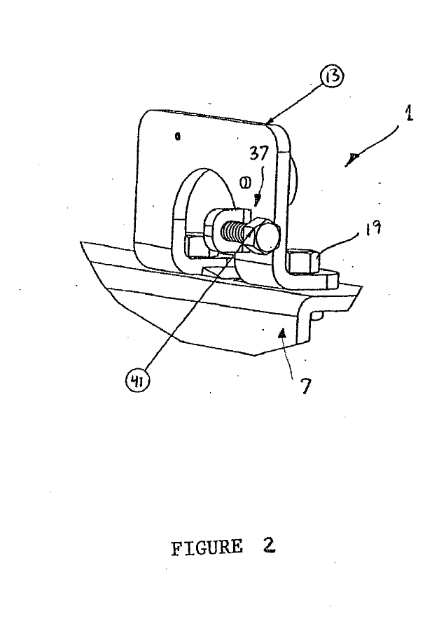

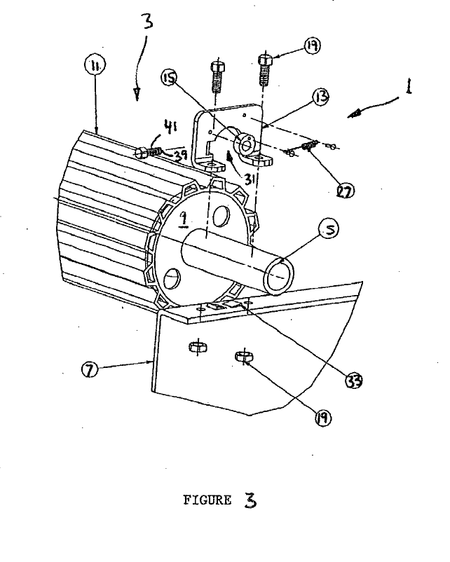

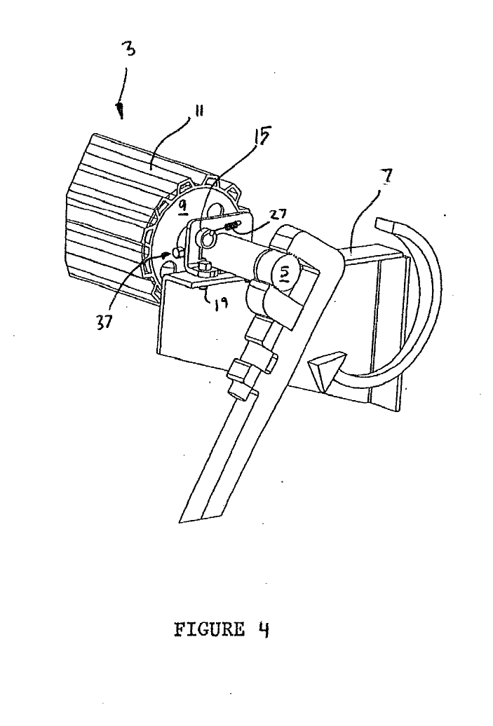

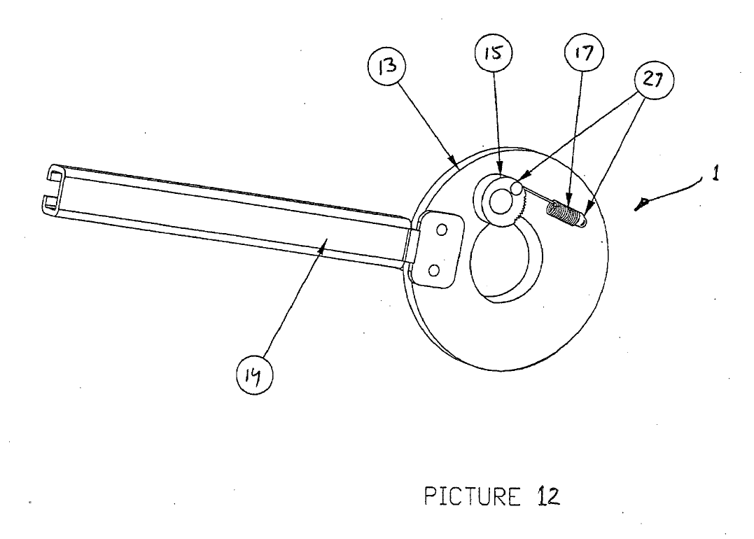

According to the present invention, and as better shown in FIGS. 1-6, the ratchet-like system 1 comprises at least one support bracket 13, at least one cam 15, and biasing means 17. As better shown in FIGS. 3-5, the support bracket 13 is preferably securely mountable onto the fixed structure 7 of the corresponding rolling door assembly 3 by means of suitable fasteners 19, but may also consist of a movable support bracket 13, in which case the ratchet-like system 1 is used as a winding tool, as better shown in FIGS. 12-14. When the ratchet-like system 1 is used as a winding tool, the support bracket 13 is preferably provided with an actuating arm 14.

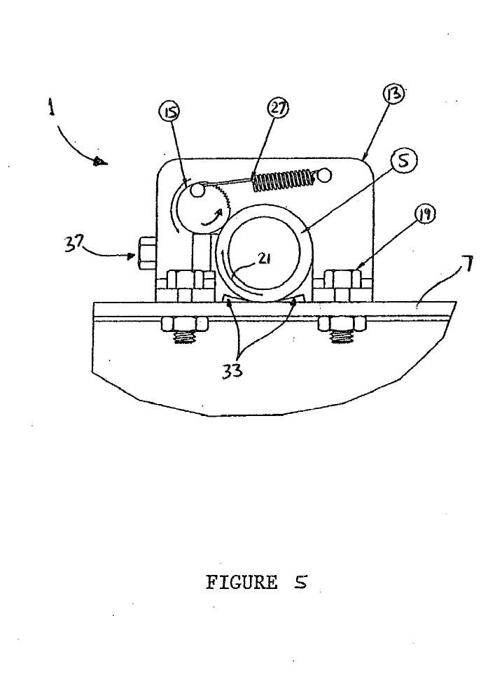

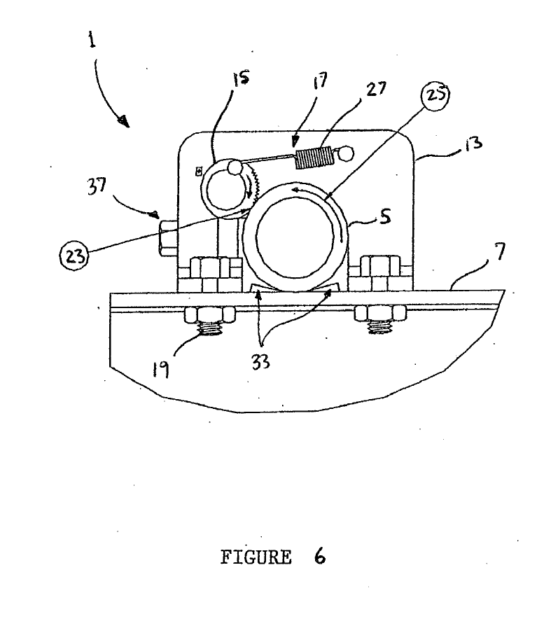

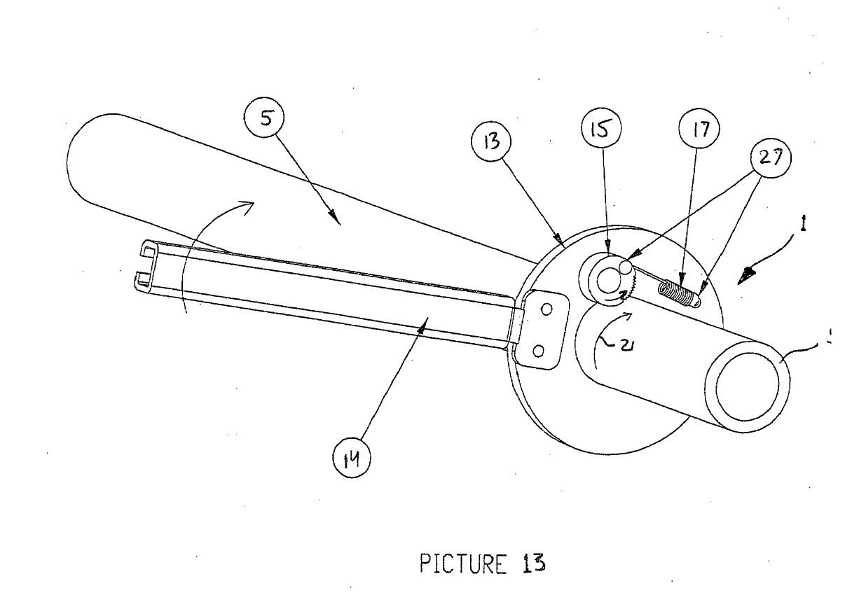

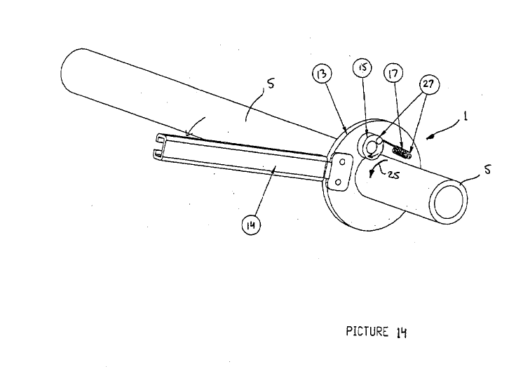

The cam 15 according to the present invention is pivotally mounted about the support bracket 13 and positioned adjacent to a portion of the overhead shaft 5. The cam 15 is shaped and sized to cooperate with said portion of the overhead shaft 5 between a first position, where the cam 15 allows the rotation of the overhead shaft 5 along a first direction 21, as better shown in FIGS. 5 and 13, and a second position, where the cam 15 has a surface 23 engaged with the overhead shaft 5 and where further rotation of the overhead shaft 5 along a second direction 25, opposite to the above-mentioned first direction 21, is blocked by the cam 15, as better shown in FIGS. 6 and 14. Hence, as can be easily understood, the cam 15 of the ratchet-like system 1 is preferably devised to enable a user thereof to adjustably control the rotation of the overhead shaft 5 of the rolling door assembly 3 during the winding thereof. Namely, the ratchet-like system 1 according to the present invention is preferably intended to allow rotation of the overhead shaft 5 in one direction 21, but preferably devised to impede rotation thereof along a opposite second direction 25, so as to facilitate manipulating of the rolling door assembly 3 and corresponding parts during the winding thereof.

The biasing means 17 are preferably devised for urging the surface 23 of the cam 15 onto the overhead shaft 5 so as to preferably ensure a substantial and/or continuous contact between the cam 15 and the surface of the overhead shaft 5, as shown in FIGS. 5 and 6, and thus ensure a fairly rapid blocking of the overhead shaft 5 when the latter is rotated along the second opposite direction 25, as apparent to a person skilled in the art.

As also better shown in FIGS. 5 and 6, the biasing means 17 are operatively connected between the support bracket 13 and the cam 15 so as to exert a biasing force for biasing the surface 23 of the cam 15 towards the overhead shaft 5. The biasing means 17 preferably comprise a loaded spring member 27, capable of storing potential energy via deformation so as to provide a potential force, the spring member 27 having a first end operatively connected to the support bracket 13 and a second end operatively connected to the cam 15. It is worth mentioning however that other suitable biasing means 17 which do not use potential energy for providing a biasing force may be used according to the present invention, so long as these biasing means 17 are capable of biasing the surface 23 of cam 15 in a suitable way towards the overhead shaft 5, as apparent to a person skilled in the art.

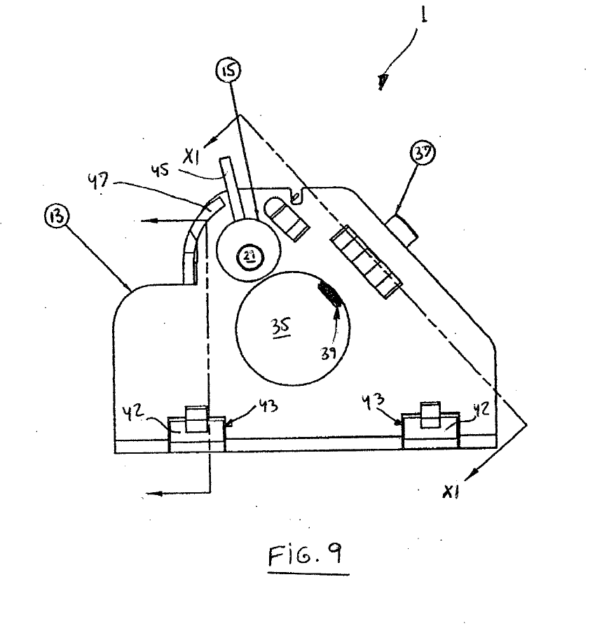

As better shown in FIGS. 5, 9, and 12, the cam 15 is preferably an oval-shaped (e.g. round, ellipse, etc.) cam 15 being eccentrically mounted onto the support bracket 13. It is worth mentioning though that other suitable geometries and dispositions can be used for the cam 15 and corresponding support bracket 13 so as to ensure a rotation of the overhead shaft 5 along a first direction 21 but also prevent the latter from being rotated when rotated in a second opposite direction 25.

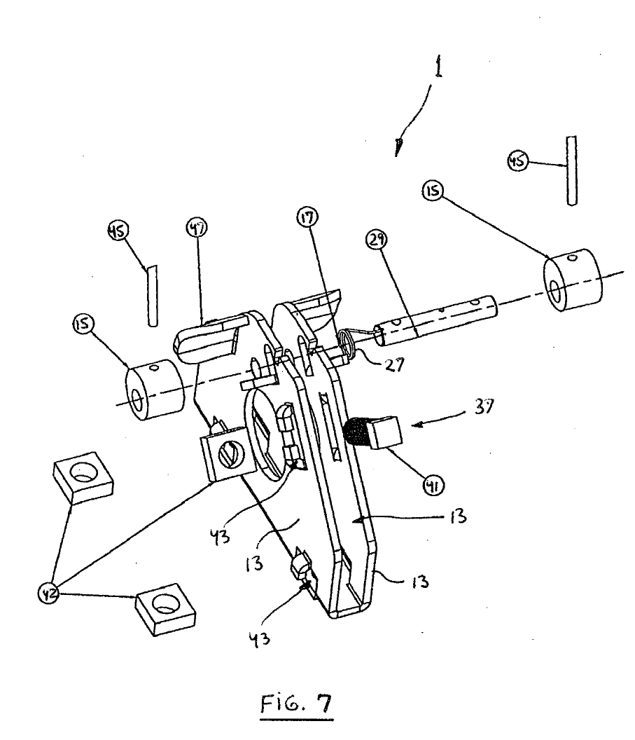

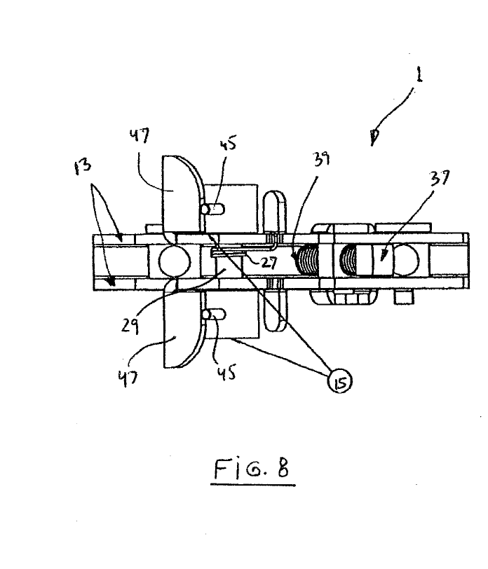

Preferably, as aforementioned, the biasing means 17 comprise a loaded spring 27 being operatively connected between the support bracket 13 and the cam 15. Preferably also, the spring member 27 has first and second ends operatively connected to the support bracket 13 and the cam 15 respectively, as better shown in FIGS. 1-6. Once again, it is worth mentioning that the biasing means 17 may have other suitable dispositions on the ratchet-like system 1 so as to ensure a corresponding biasing force on the cam 15 towards the overhead shaft 5. Indeed, for example, as better shown in FIGS. 7-8, the biasing means 17 may comprise a spring member 27 having first and second ends operatively connected to the support bracket 13 and a pin 29 about which the cams 15 are mounted. It is also worth mentioning that, according to the present invention, the spring member 27 is not absolutely necessary for proper operation of the ratchet-like system 1. Indeed, the biasing means 17 may simply consist of the effect of gravity acting on the cam(s) 15, in which case, the cam(s) 15 would be positioned, shaped, and sized onto the support bracket 13 so that, by virtue of the effect of gravity acting thereon, it would have a surface 23 in physical contact with the overhead shaft 5, as apparent to a person skilled in the art.

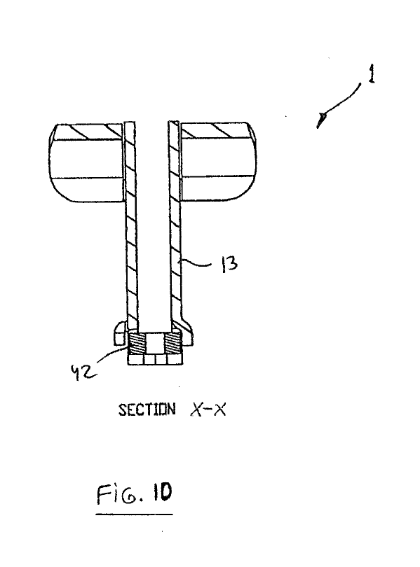

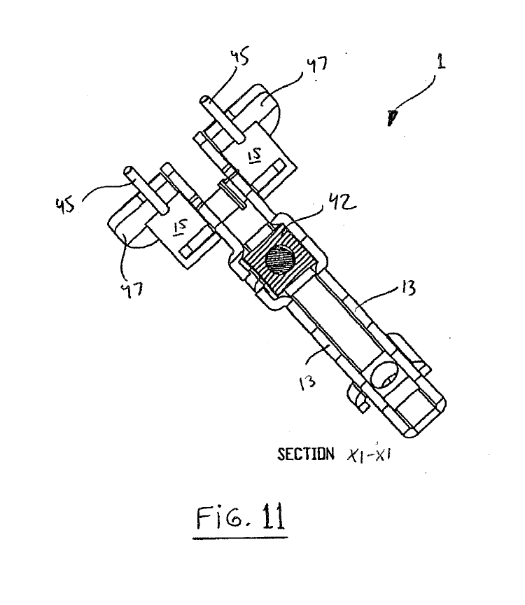

As better shown in FIGS. 1-6, the support bracket 13 preferably has an opening 31 through which extends the overhead shaft 5, and the fixed structure 7 about which the support bracket 13 is mounted preferably has corresponding supporting lips 33 about which the overhead shaft 5 may be rested. Alternatively, the support bracket 13 preferably comprises an orifice 35 through which extends the overhead shaft 5, as better shown in FIGS. 7-14. It may be appreciated that a support bracket 13 with such an orifice 35 is substantially more rigid sound than a U-shaped bracket 13, as shown in FIGS. 1-6, and that the orifice 35 of said support bracket 13 may be used as a guiding and support device for the overhead shaft 5.

Although not absolutely necessary for proper operation of the ratchet-like system 1 according to the present invention, the latter preferably comprises a safety device 37 being mounted about the support bracket 13 and being movable with respect to the same, the safety device 37 having an end 39 adjacent to a contact point on the overhead shaft 5, and this end 39 of the safety device 37 being operable between a first position where said end is away from the contact point of the overhead shaft 5, and a second position, where the end 39 is secured against the contact point of the overhead shaft 5 for immobilizing the overhead shaft 5 from being rotated along either direction with respect to the support bracket 13 of the ratchet-like system 1. Indeed, once the rolling door assembly 3 has been properly wound (i.e. adjusted, calibrated, counterbalanced, etc.), the ratchet-like system 1 according to the present invention and corresponding cam(s) 15 prevent adverse rotation of the overhead shaft 5 along a second opposite direction 25, and thus acts as a stopper for such a rotation. As a protective measure, the ratchet-like system 1 may comprise the above-mentioned safety device 37 for maintaining the overhead shaft 5 in a stable and fixed configuration, upon proper winding of the rolling door assembly 3, so as to not have to rely entirely on the ratchet-like system 1. Thus, as can be easily appreciated, the safety device 37 of the ratchet-like system 1 is not an essential feature thereof but provides the same with substantial advantages. Preferably, as better shown in FIGS. 7-9, the safety device 37 may consist of a suitable fastener 41 threadedly engaged into a corresponding nut 42 of the ratchet-like system 1, and being adjustably screwed or unscrewed so as to selectively secure the same against the outer surface of the overhead shaft 5, and selectively, block rotation thereof. Indeed, the safety device 37 preferably consist of a simple fastener 41 having a first portion threadedly engaged onto the support bracket and/or a piece thereof, such as a flange as shown in FIG. 1, and an end 39 cooperable with the overhead shaft 5 in the manner discussed above.

As can be easily understood when referring to FIGS. 1-9, the support bracket 13 of the ratchet-like system 1 according to the present invention is preferably securely mountable onto the fixed structure by means of corresponding suitable fasteners 19, and the support bracket 13 preferably comprises corresponding recesses 0.43 for receiving the fasteners 19. The fasteners 19 may consist of a bolt combined with other suitable complementary pieces, such as a nut 42, a washer, a spacer, and/or the like, as exemplified in FIG. 7 and as apparent to a person skilled in the art.

Preferably also, as better shown in FIGS. 7-11, the cam 15 is provided with a lever arm 45 for allowing a user of the ratchet-like system 1 to urge the cam 15 away from the overhead shaft 5, so as to enable rotation of the overhead shaft 5 along the second direction 25, during unwinding of the rolling door assembly 3, if required.

Preferably also, as better shown in FIGS. 7-9, the support bracket 13 comprises protective flanges 47 shaped, positioned, and sized so as to cover a substantial portion of the cam(s) 15, and prevent the cam(s) 15 from being accidentally tampered with.

It is worth mentioning though that, according to the present invention, the safety device 37 may be disposed otherwise on support bracket 13 and/or on other parts of the ratchet-like system 1, as briefly described hereinbelow and as apparent to a person skilled in the art.

According to another aspect of the present invention, there is also provided a kit comprising some or several of the preferred components constituting the ratchet-like system 1 according to the present invention, as exemplified in FIG. 7, so that a user may employ these components and assemble them so as to obtain a ratchet-like system 1 having the structural components and displaying the features described hereinabove.

According to another aspect of the present invention, there is provided a rolling door assembly 3 provided with the above-mentioned ratchet-like system 1.

The ratchet-like system 1 and corresponding parts (support bracket 13, cam 15, etc.) are preferably made of substantially rigid materials, such as metallic materials (steel, etc.), hardened polymers, composite materials, and/or the like, so as to ensure a proper operation thereof depending on the particular applications for which the ratchet-like system 1 is intended and the different parameters in cause (counterbalancing force in the spring, weight of the door, number of cycles, etc.), as apparent to a person skilled in the art.

Following is a typical use of the present ratchet-like system 1 intended for winding a rolling door assembly 3. The shaft 5 of the assembly 3 which is typically connected to a counterbalancing spring, as aforementioned, is preferably placed on a fixed structure 7, such as wall brackets for example. Preferably also, the brackets 13 of the rolling door assembly 3 are then bolted to the corresponding wall brackets around the shaft 5. The system is then operational. A garage door installer can then turn the shaft 5 with a pipe wrench or a special tool, and the eccentric cam 15 will open and let the shaft 5 turn freely, as better shown in FIGS. 5 and 13. When the installer stops turning the shaft, the shaft being now under tension created by the torque spring on the door assembly 3, said torque is maintained by the cam effect which blocks the overhead shaft 5 from being rotated along a second opposite direction 25, in any position under tension, as better shown in FIGS. 6 and 14. When the required torque is reached, as apparent to a person skilled in the art, the fasteners 19 are then tightened to block any movement of the overhead shaft 5 and ensure the normal operation and safety of the rolling door assembly 3. More specifically, FIG. 5 shows the shaft 5 after having been rotated in a clockwise direction. This rotation forces the cam 15 to rotate in a counterclockwise direction. If the overhead shaft 5, by virtue of the tension torque present on the counterbalancing spring, attempts to lower its torque by turning counterclockwise, the cam 15 simply rotates clockwise by an amount sufficient for friction means to interact, such as a knurled portion or teeth of the surface 23 of the cam 15, as illustrated in FIG. 6, engaging the shaft 5 and thus preventing further rotation thereof.

It is to be understood that several modifications could be made to the present ratchet-like system 1 according to the present invention without departing from the scope of the present invention. Indeed, as aforementioned, the cam(s) 15 may be shaped, positioned, and sized in such a way that the effect of gravity will act to replace the biasing force of a spring member 27. Moreover, the counterbalancing spring may be direct to the shaft 5 but also be installed directly on the wall bracket as in the case with commercial garage doors and residential doors. In such cases, some modifications would have to be made, but the general principles of the present ratchet-like system 1 allowing the overhead shaft 5 to be rotated along one direction 21, but preventing the rotation thereof in a second opposite direction 25, will still be possible to use. Moreover, according to the present invention, the ratchet-like system 1 may comprise a plurality of cams 15, such as a pair of cams 15, as better shown in FIGS. 7-9. In such case, the ratchet-like system 1 is preferably devised to be symmetrical, so that either side may be used on a corresponding end of the overhead shaft 5. It is also worth mentioning that the cam 15 may or may not be provided with a teeth to increase friction between the shaft 5 and the cam 15. Alternatively, as also apparent to a person skilled in the art, the cam surface 23 may be provided with other suitable friction means for ensuring a proper engagement between the cam 15 and the overhead shaft 5 when the latter is rotated along the second direction 25.

As may now be better appreciated, the present invention is a substantial improvement and presents several advantages over devices and/or methods known on the prior art. Indeed, the present invention may be used in the garage door industry, with new door assemblies 3 or existing door assemblies 3. In such cases, the present invention is devised to securely control rotation of the overhead shaft 5 of the rolling door assembly 3 during winding thereof and thus prevent significant damages to property and serious personal injuries to people. The present invention is a compact, reliable, easy to use, easy to maintain, and cost effective system for winding rolling door assemblies 3. Moreover, the present ratchet-like system 1 provides an easier and safer way of winding rolling door assemblies 3 than what is possible with the devices and/or method available in the prior art. Furthermore, the present invention may be used with other kinds of door assemblies 3, such as fire doors and/or shutters for example, or with any other items provided with a shaft requiring to be properly adjusted, rotation-wise, as aforementioned and as apparent to a person skilled in the art.

Of course, numerous modifications could be made to the above-described embodiments without departing the scope of the invention, as defined in the appended claims.

1. A ratchet-like system for winding a rolling door assembly having an overhead shaft mounted about a fixed structure and rotatable thereabout along opposite first and second directions, a drum mounted about said overhead shaft, a door curtain foldable about the drum and unfoldable from the same via a rotation of the drum, and a counterbalancing spring operatively connected between the overhead shaft and the drum for counterbalancing the rolling door assembly when the overhead shaft is secured to the fixed structure, the ratchet-like system comprising:
at least one support bracket;
at least one cam pivotally mounted about the at least one support bracket and positioned adjacent to a portion of the overhead shaft, said at least one cam being shaped and sized to cooperate with said portion of the overhead shaft between a first position, where the at least one cam allows rotation of the overhead shaft along the first direction, and a second position, where the at least one cam has a surface engaged with the overhead shaft and where further rotation of the overhead shaft along the second direction is blocked by the at least one cam; and
biasing means for urging the surface of the at least one cam onto the overhead shaft.

2. A ratchet-like system according to claim 1, wherein the at least one cam is an oval-shaped cam being eccentrically mounted onto the at least one support bracket.

3. A ratchet-like system according to claim 1, wherein the biasing means comprise a loaded spring operatively connected between the at least one support bracket and the at least one cam.

4. A ratchet-like system according to claim 1, wherein the at least one support bracket comprises an orifice through which extends the overhead shaft.

5. A ratchet-like system according to claim 1, wherein the system further comprises a safety device mounted about the at least one support bracket and being movable with respect to the same, the safety device having an end adjacent to a contact point on the overhead shaft, the end of the safety device being operable between a first position where said end is away from the contact point of the overhead shaft, and a second position, where said end is secured against the contact point of the overhead shaft for immobilizing the overhead shaft from being rotated with respect to the at least one support bracket of the ratchet-like system.

6. A ratchet-like system according to claim 1, wherein the at least one support bracket is securely mountable onto the fixed structure by means of fasteners.

7. A ratchet-like system according to claim 1, wherein the at least one support bracket comprises recesses for receiving corresponding fasteners.

8. A ratchet-like system according to claim 1, wherein said surface of the at least one cam is knurled.

9. A ratchet-like system according to claim 1, wherein the at least one cam is provided with a lever arm for allowing a user to urge said at least one cam away from the overhead shaft.

10. A ratchet-like system according to claim 1, wherein the biasing means consist of the effect of gravity acting on the cam.

11. A ratchet-like system according to claim 1, wherein the ratchet-like system comprises first and second cams pivotally mounted on either side of the at least one support bracket about a common pin.

12. A ratchet-like system according to claim 11, wherein each cam is an oval-shaped cam being eccentrically mounted onto the at least one support bracket.

13. A ratchet-like system according to claim 11, wherein the biasing means comprise a loaded spring operatively connected between the pin and the at least one support bracket.

14. A ratchet-like system according to claim 11, wherein the at least one support bracket comprises an orifice through extends the overhead shaft.

15. A ratchet-like system according to claim 11, wherein the system further comprises a safety device mounted about the at least one support bracket and being movable with respect to the same, the safety device having an end adjacent to a contact point on the overhead shaft, the end of the safety device being operable between a first position where said end is away from the contact point of the overhead shaft, and a second position, where said end is secured against the contact point of the overhead shaft for immobilizing the overhead shaft from being rotated with respect to the at least one support bracket of the ratchet-like system.

16. A ratchet-like system according to claim 11, wherein the at least one support bracket is securely mountable onto the fixed structure by means of fasteners, and wherein said at least one support bracket comprises recesses for receiving said fasteners.

17. A ratchet-like system for winding a rolling door assembly having an overhead shaft mounted about a fixed structure and rotatable thereabout along opposite first and second directions, the ratchet-like system comprising:
at least one support bracket;
at least one cam pivotally mounted about the at least one support bracket and positioned adjacent to a portion of the overhead shaft, said at least one cam being shaped and sized to cooperate with said portion of the overhead shaft between a first position, where the at least one cam allows rotation of the overhead shaft along the first direction, and a second position, where the at least one cam has a surface engaged with the overhead shaft and where further rotation of the overhead shaft along the second direction is blocked by the at least one cam; and
biasing means for urging the surface of the at least one cam onto the overhead.

18. A kit for assembling a ratchet-like system for winding a rolling door assembly having an overhead shaft mounted about a fixed structure and rotatable thereabout along opposite first and second directions, a drum mounted about said overhead shaft, a door curtain foldable about the drum and unfoldable from the same via a rotation of the drum, and a counterbalancing spring operatively connected between the overhead shaft and the drum for counterbalancing the rolling door assembly when the overhead shaft is secured to the fixed structure, the kit comprising:
a support bracket; and
a cam pivotally mountable about the support bracket and positionable adjacent to a portion of the overhead shaft, said cam being shaped and sized so that, once the ratchet-like system assembled, the cam cooperates with said portion of the overhead shaft between a first position, where the cam allows rotation of the overhead shaft along the first direction, and a second position, where the cam has a surface engaged with the overhead shaft and where further rotation of the overhead shaft along the second direction is blocked by the cam.

19. A kit according to claim 18, further comprising biasing means operatively connectable between the cam and the support bracket for urging the surface of the cam onto the overhead shaft.

20. A kit according to claim 18, further comprising fasteners for securely mounting the support bracket onto the fixed structure.
